(19) United States
(12) Patent Application Publication
(10) Pub. No.: US 2026/0243094 A1
(43) Pub. Date: Aug. 20, 2026

(54) CONCRETE VIBRATOR SYSTEM

(71) Applicant: MILWAUKEE ELECTRIC TOOL CORPORATION, Brookfield, WI (US)

(72) Inventors: Manuel Alfonso Valadez, Torreón (MX); Edgar Olguin Holguin, Torreón (MX)

(21) Appl. No.: 19/539,206

(22) Filed: Feb. 13, 2026

Related U.S. Application Data
(60) Provisional application No. 63/806,087, filed on May 15, 2025.
(60) Provisional application No. 63/759,899, filed on Feb. 18, 2025.

(51) Int. Cl. E04G 21/06; E04G 21/08; F16F 9/32

(52) U.S. Cl. CPC E04G 21/066; E04G 21/08; F16F 9/3257

(57) ABSTRACT

A concrete vibrator system includes a portable power unit, a cable extending from the portable power unit, and a high cycle concrete vibrator coupled to the cable to receive electrical current from the battery pack. The high cycle concrete vibrator includes a whip with a first end and an opposite, second end. A vibrating head connected to the second end of the whip includes an onboard electric motor for rotating a drive shaft to which an eccentric mass is affixed. The concrete vibrator system includes a pistol-grip handle positioned between the portable power unit and the whip. The cable extends into the pistol-grip handle. The pistol-grip handle includes a main body including a grip. The pistol-grip handle includes a damper assembly positioned between the main body and the first end of the whip. The damper assembly attenuates vibration transmitted from the vibrating head to the grip.

### CROSS-REFERENCE TO RELATED APPLICATIONS

This application claims priority to U.S. Provisional Patent Application No. 63/806,087, filed on May 15, 2025, and to U.S. Provisional Patent Application No. 63/759,899, filed on February 18, 2025, the entire contents of all of which are incorporated herein by reference.

### FIELD OF THE INVENTION

The present invention relates to power tools, and more particularly to concrete vibrators.

### BACKGROUND OF THE INVENTION

Concrete vibrators are typically used to spread poured concrete around a framework, such as rebar, in a construction operation. Such concrete vibrators are typically powered by an internal combustion engine, which can be difficult to carry by an operator using the concrete vibrator while on a worksite.

### SUMMARY OF THE INVENTION

In one aspect, a concrete vibrator system includes a portable power unit including a backpack including a strap to allow a user to carry the portable power unit on a back of the user, a battery receptacle unit, and a battery pack attached to the battery receptacle unit. The concrete vibrator system includes a cable extending from the portable power unit. The cable transmits electrical current from the battery pack. The concrete vibrator system includes a high cycle concrete vibrator coupled to the cable to receive the electrical current from the battery pack. The high cycle concrete vibrator includes a whip including a first end and an opposite, second end, and a vibrating head coupled to the second end of the whip. The vibrating head includes an onboard electric motor configured to rotate a drive shaft to which an eccentric mass is affixed. The concrete vibrator system includes a pistol-grip handle positioned between the portable power unit and the whip. The cable extends into the pistol-grip handle. The pistol-grip handle includes a main body including a grip, and a damper assembly positioned between the main body and the first end of the whip. The damper assembly attenuates vibration transmitted from the vibrating head to the grip.

In another aspect, a concrete vibrator system includes a portable power unit including a battery receptacle unit, and a battery pack attached to the battery receptacle unit. The concrete vibrator unit includes a cable extending from the portable power unit. The cable transmits electrical current from the battery pack. The concrete vibrator system includes a high cycle concrete vibrator coupled to the cable to receive the electrical current from the battery pack. The high cycle concrete vibrator includes a whip including a first end and an opposite, second end, and a vibrating head coupled to the second end of the whip. The vibrating head includes an onboard electric motor configured to rotate a drive shaft to which an eccentric mass is affixed. The concrete vibrator system includes a pistol-grip handle positioned between the portable power unit and the whip. The cable extends into the pistol-grip handle. The pistol-grip handle includes a main body including a grip, a handle receptacle, and a handle control panel that is operable to be controlled by a thumb of a user’s hand while the user’s hand is holding the grip. The handle control panel is located on a remote control unit that is selectively receivable within the handle receptacle.

In another aspect, a pistol-grip handle for a concrete vibrator includes a main body including a first clamshell half and a second clamshell half. The first and second clamshell halves form a grip and an interior cavity. The pistol-grip handle further includes a strain relief component that supports an electrical cable extending into the interior cavity. The electrical cable transmits electrical current from a power source to the concrete vibrator. The pistol-grip handle further includes a damper assembly. The damper assembly includes a first damper coupled to the main body and having a first Shore hardness, and a second damper coupled between the first damper and the concrete vibrator. The second damper has a second Shore hardness that is less than the first Shore hardness of the first damper. The damper assembly attenuates vibration transmitted from the concrete vibrator to the grip.

Other features and aspects of the invention will become apparent by consideration of the following detailed description and accompanying drawings.

### BRIEF DESCRIPTION OF THE DRAWINGS

FIG. 1A is a perspective view of a portable power unit for use with a concrete vibrator.

FIG. 1B is a concrete vibrator for use with the portable power unit of FIG. 1A.

FIG. 1C is a perspective view of a portable power unit carried on a back of a user, for use with the concrete vibrator of FIG. 1B.

FIG. 1D is a perspective view of a handle for operating the concrete vibrator of FIG. 1B according to an embodiment of the invention.

FIG. 1E is another perspective view of the handle of FIG. 1D.

FIG. 2A is a perspective view of the handle of FIG. 1D held in a left hand of the user.

FIG. 2B is a top view of the handle of FIG. 1D held in the left hand of the user.

FIG. 2C is a top view of the handle of FIG. 1D held in the right hand of the user.

FIG. 3A is another top view of the handle of FIG. 1D.

FIG. 3B is a side view of the handle of FIG. 1D.

FIG. 4 is a schematic view of the concrete vibrator of FIG. 1B and a handle according to another embodiment of the invention.

FIG. 5 is another schematic view of a portable power unit, the concrete vibrator, and a handle according to another embodiment of the invention.

FIG. 6 is a perspective view of a damper assembly for use with the handles of FIGS. 4 or 5.

FIG. 7 is an exploded view of the damper assembly of FIG. 6, including a hose adaptor, a damper, and a damper adaptor.

FIG. 8A is a perspective view of the handle of FIG. 5 coupled to the damper assembly of FIG. 6.

FIG. 8B is another perspective view of the handle of FIG. 5.

FIG. 8C is a table of test results showing acceptable exposure time for varying amplitudes of hand-arm vibration.

FIG. 9 is a perspective view of the hose adaptor of FIG. 7.

FIG. 10A is a perspective view of the damper of FIG. 7.

FIG. 10B is a side elevation view of the damper of FIG. 7.

FIG. 10C is a cross-sectional view of the damper of FIG. 7 along the line 10C-10C of FIG. 10B.

FIG. 10D is a table of hardness test results of the damper of FIG. 7.

FIG. 11A is a perspective view of the damper adaptor of FIG. 7.

FIG. 11B is a table of hardness test results for the damper adaptor of FIG. 7.

FIG. 12A is an exploded view of a damper assembly for use with any of the handles of FIGS. 4 or 5, including a hose adaptor, a damper, and a damper adaptor.

FIG. 12B is a cross-sectional view of the damper assembly of FIG. 12Aillustrating a double-overmold construction.

FIG. 13A is a perspective view of a handle for operating a concrete vibrator, according to an embodiment of the invention, the handle including a damper assembly.

FIG. 13B is a schematic side view of the handle of FIG. 13A.

FIG. 13C is an enlarged perspective view of a portion of the handle of FIG. 13A shown within the region 13C-13C of FIG. 13B.

FIG. 13D is a perspective view of a strain relief component for protecting an electrical cable within the handle of FIG. 13A, located within the region 13D-13D of FIG. 13B.

FIG. 14A is a perspective view of a handle for operating a concrete vibrator, according to an embodiment of the invention, the handle including a damper assembly.

FIG. 14B is a perspective view of the handle of FIG. 14A with some components removed.

FIG. 14C is a side view of the handle of FIG. 14A.

FIG. 15 is a front view of the handle of FIG. 14A.

FIG. 16 is a cross-sectional view of the handle of FIG. 14A along the line 16-16 of FIG. 15.

FIG. 17 is a top view of the handle of FIG. 14A.

FIG. 18 is a perspective view of a handle for operating a concrete vibrator according to an embodiment of the invention, the handle including a hook assembly.

FIG. 19 is a perspective view of the handle of FIG. 18.

FIG. 20 is a perspective view of the handle of FIG. 18 with the hook assembly supporting the handle in a first hooked position.

FIG. 21 is a perspective view of the handle of FIG. 18 with the hook assembly supporting the handle in a second hooked position.

FIG. 22 is a perspective view of the handle of FIG. 18, the handle being gripped by a user.

FIG. 23 is a schematic side view of the handle of FIG. 18.

FIG. 24 is a side view of the handle of FIG. 18.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

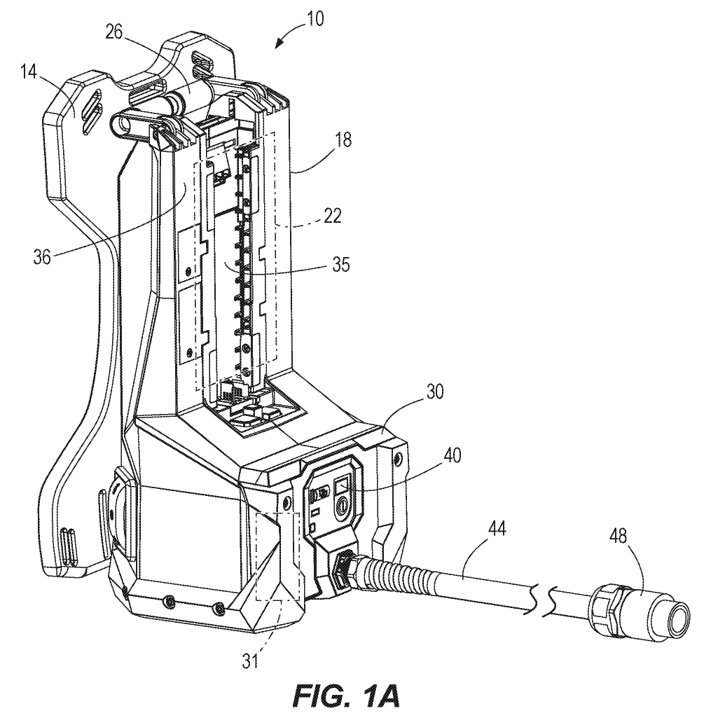

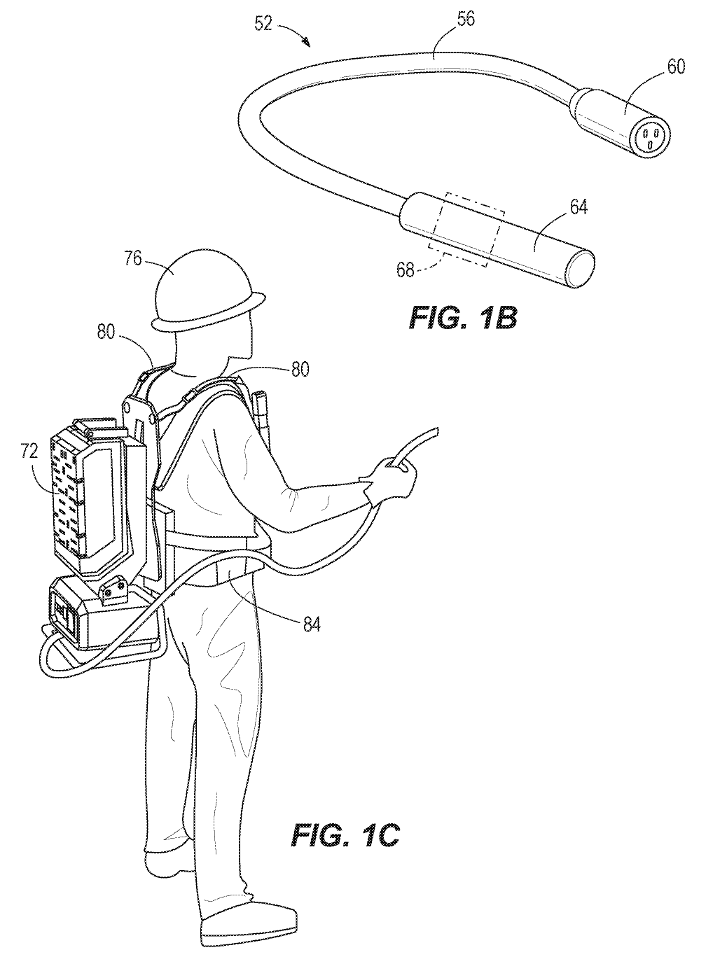

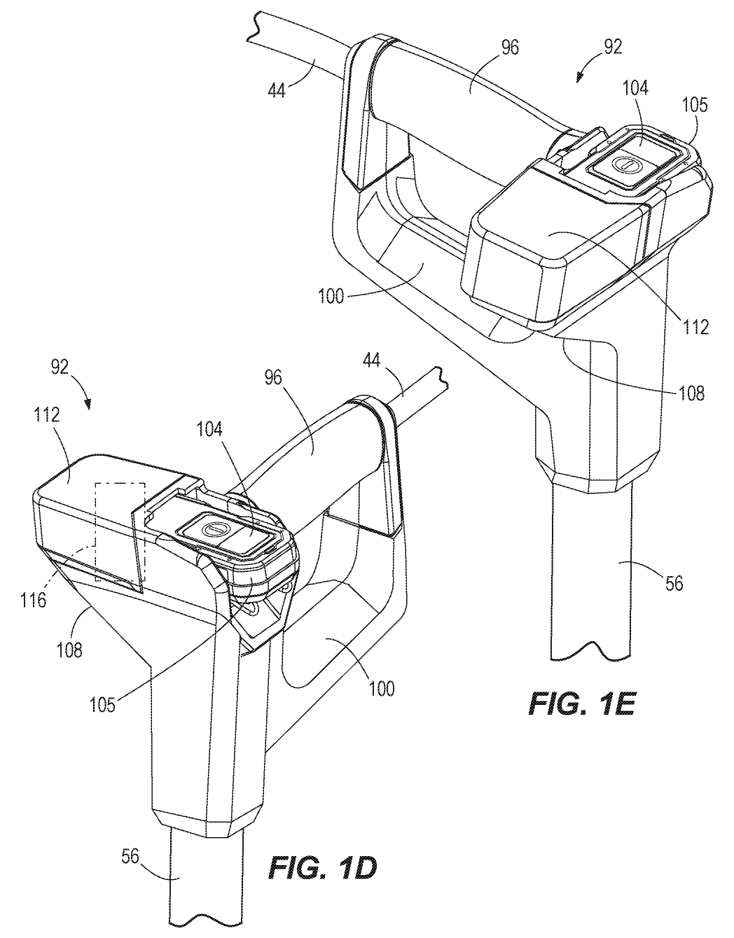

With reference to FIG. 1A, a portable power unit 10 includes a frame or backpack 14, a battery receptacle unit 18, a rechargeable battery pack 22 (shown schematically in FIG. 1A) attached to the battery receptacle unit 18, a handle 26 to facilitate hand-carrying the unit 18, and a motor control unit 30. The backpack 14 generally defines a backpack plane and includes straps or other rigging to allow a user to carry the portable power unit 10 on the user’s back while the portable power unit 10 is in use or between uses of the portable power unit 10. The straps may include one, two, or more shoulder straps and one or more waist straps. The battery receptacle unit 18 includes a battery receptacle 35 on a front side 36 of the unit 18 to which the battery pack 22 is attachable, with the backpack 14 being attached to a rear side of the unit 18, which is opposite the front side 36. A control panel 40 (which may also be referred to as a power unit control panel 40) may be positioned on the unit 18 and, in some embodiments, on the motor control unit 30. In operation, a user may interact with actuators on the motor control unit 30 to control an operation of the portable power unit 10 and/or a tool to which the portable power unit 10 is connected. The motor control unit 30 may include an electronic control unit 31 (schematically shown in FIG. 1A) such as, for example, a printed circuit board that receives inputs and sends a control signal to a tool to which the portable power unit 10 is connected (e.g., a concrete vibrator). An electrical cable 44 extends from the unit 18 and, in some embodiments, from the motor control unit 30. The electrical cable 44 may include one or more wires and may carry the control signal sent by the electronic control unit 31 to the tool to which the portable power unit 10 is connected. The cable 44 includes a cable end 48. The cable 44 transmits electrical current from the battery pack 22 to a tool coupled to the cable end 48.

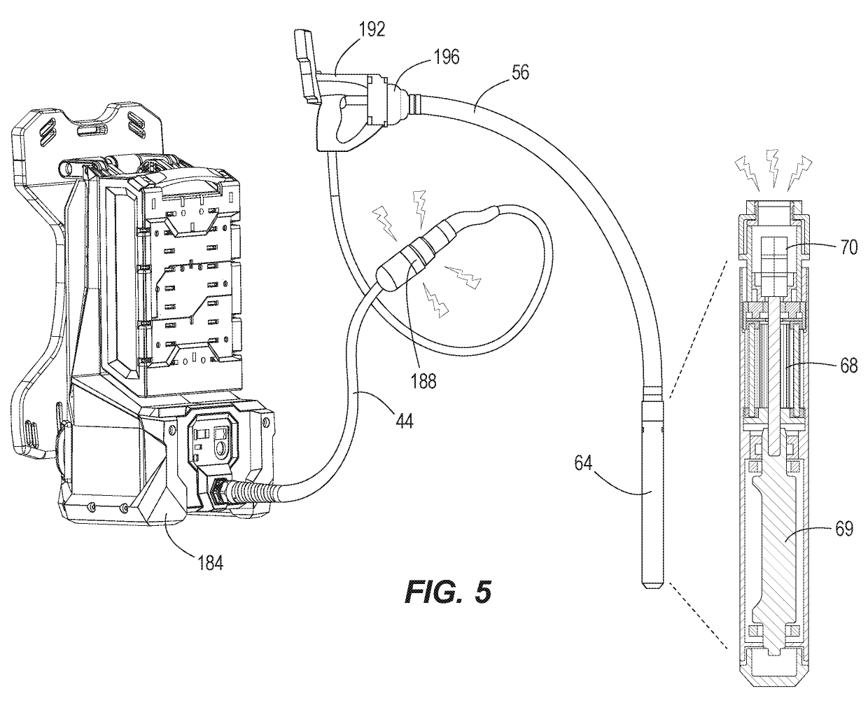

With reference to FIG. 1B, a concrete vibrator such as a high cycle concrete vibrator 52 may be powered and controlled by the portable power unit 10, thereby forming a concrete vibrator system. The high-cycle concrete vibrator 52 includes a whip 56 (which may also be referred to as a hose 56) having a first end and an opposite, second end. The high cycle concrete vibrator 52 includes whip connection 60 at the first end of the whip 56, which electrically connects the whip 56 to the cable 44. The high cycle concrete vibrator 52 includes a vibrating head 64 at (e.g., coupled to, attached to, etc.) the second end of the whip 56 (i.e., at a distal end of the whip 56 or hose 56). The vibrating head 64 contains an onboard electric motor 68 (shown schematically in FIG. 1B), which in some embodiments is a brushless direct current (“BLDC”) electric motor 68 that is configured to rotate a drive shaft to which an eccentric mass 69 is affixed (FIG. 5). The vibrating head 64 may also include onboard motor electronics 70 (FIG. 5).

With reference to FIG. 1C, an embodiment of a portable power unit 72 (which may be generally similar to the portable power unit 10 except as is noted and/or as is illustrated by the figures) may be borne on a back of a user 76 by means of shoulder straps 84 and a waist strap 88. The portable power unit 10 may similarly be borne on the back of the user 76 by means of the shoulder straps 80 and the waist strap 84.

With reference to FIGS. 1D and 1E, a handle 92 (e.g., a pistol-grip handle 92as shown in the illustrated embodiment) may be connected to the cable 44 and, more specifically, to the cable end 48. The handle 92 may also be connected to the whip 56 and, more specifically, to the whip connection 60. The handle 92 is positioned between the cable 44 and the whip 56 and between the portable power unit 10, 72 and the whip 56 such that the user 76 may use the handle 92 to manipulate and/or control the high cycle concrete vibrator 52. The handle 92 includes a main body having a grip 96, a hand guard 100, a control panel 104 (which may also be referred to as a handle control panel 104), a controller housing 108, and an overmold 112 to protect the controller housing 108. The controller housing 108 includes a controller 116 (e.g., a printed circuit board 116 shown schematically in FIG. 1D) that may receive inputs and, in some embodiments, may be used for controlling the vibrating head 64 (e.g., for controlling delivery of electric current to the vibrating head 64 and/or controlling a frequency and/or amplitude of vibration of the vibrating head 64).

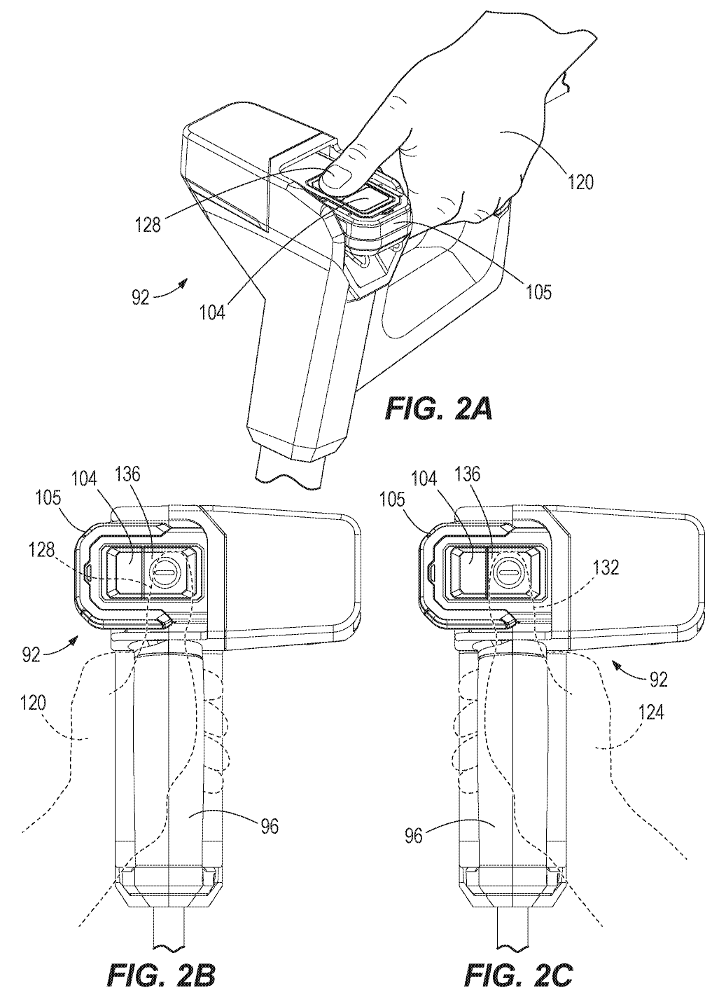

With reference to FIGS. 2A, 2B, and 2C, the user 76 may hold the grip 96 with either a left hand 120 or a right hand 124. When either the left hand 120 or the right hand 124 of the user 76 holds the grip 96, a respective left thumb 128 or right thumb 132 is appropriately positioned and operable to actuate controls on the control panel 104, including for example an on/off button 136.

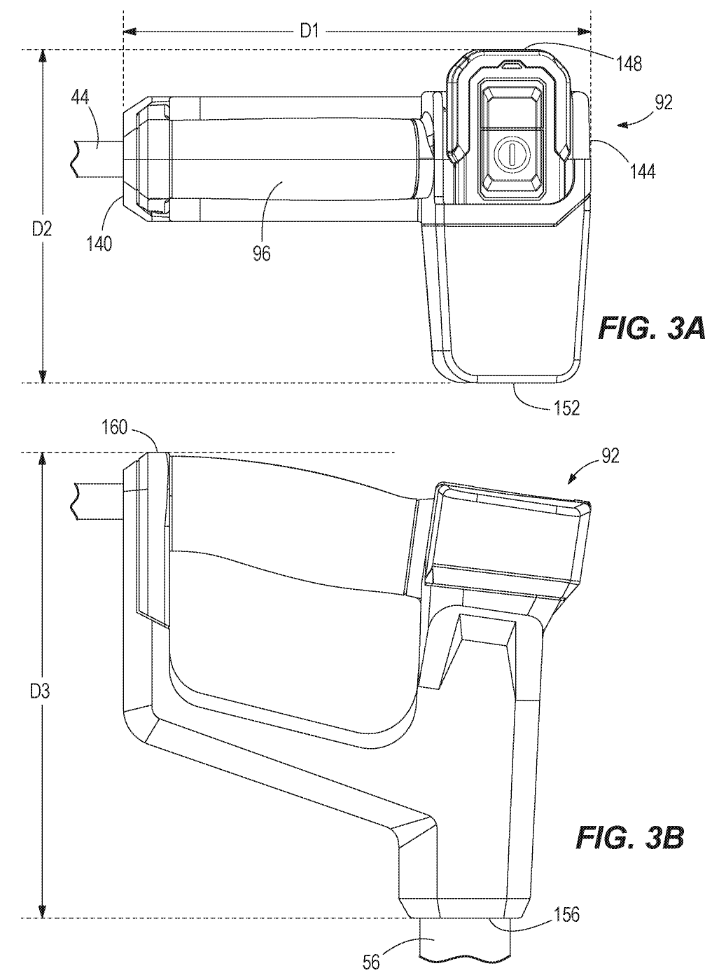

With reference to FIGS. 3A and 3B, a distance D1 between a first end 140 adjacent the cable 44 and a second end 144 opposite the first end 140 along a length approximately parallel to the grip 96 may be, in some embodiments, 193 mm or approximately 193 mm. A distance D2 between a first side 148 and a second side 152 in a direction approximately perpendicular to the grip 96 may be, in some embodiments, 135 mm or approximately 135 mm. A distance D3 between a lower side 156 adjacent the whip 56 and an opposite upper side 160 may be, in some embodiments, 193 mm or approximately 193 mm, and/or approximately equal to the distance D1.

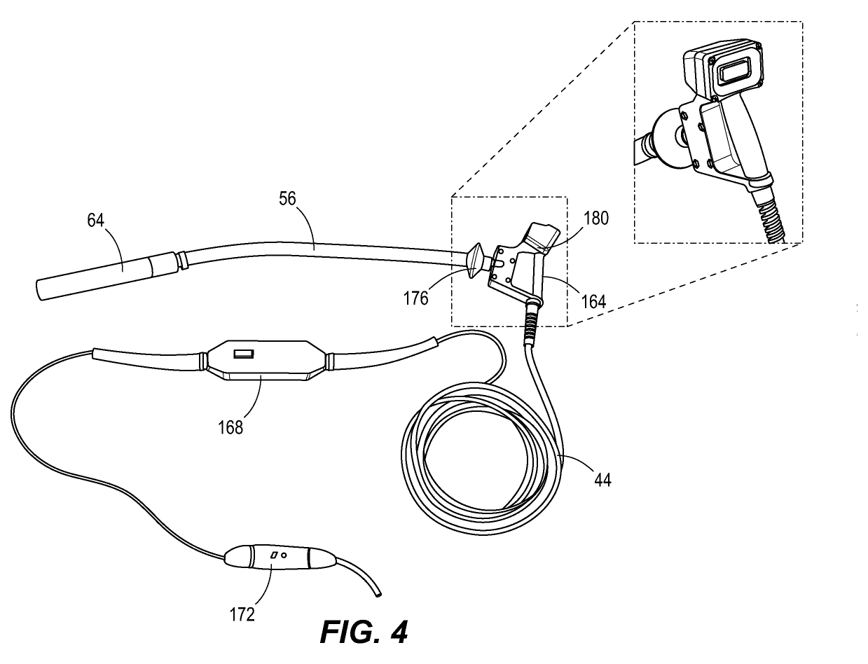

With reference to FIG. 4, another embodiment of a handle 164 (e.g., a pistol-grip handle 164 as shown in the illustrated embodiment) is connected to the whip 56, which is itself connected to the vibrating head 64. The handle 164 is also connected to the cable 44, which transmits electrical current to the vibrating head 64. The cable 44 may include one or more intermediate electrical components 168, 172, which may include fuses, switches, inverters, transformers, or the like. The handle 164 includes a damper assembly 176 is positioned between the whip 56 and a main body 180 of the handle 164. More specifically, the damper assembly 176 may be positioned between the main body 180 of the handle 164 and the first end of the whip 56. In operation, the damper assembly 176 attenuates vibration generated by the vibrating head 64 and transmitted from the vibrating head 64 to the grip 96. Accordingly, the damper assembly 176 attenuates vibration that is felt by the hand 120, 124 of the user 76 (e.g., by reducing the amplitude of vibration felt by the hand 120, 124). Other damper assemblies described herein may function similarly.

With reference to FIG. 5, a portable power unit 184 (which may be generally similar to the portable power units 10, 72 except as is noted and/or as is illustrated by the figures) is connected to a cable 44, which includes a connection 188 (e.g., a plug-type connection) positioned intermediately in the cable 44. The cable 44 transmits electrical current to a handle 192 (e.g., a pistol-grip handle 192 as shown in the illustrated embodiment), which includes a damper assembly 196. The damper assembly 196 is connected to the whip 56. The whip 56 is connected to the vibrating head 64.

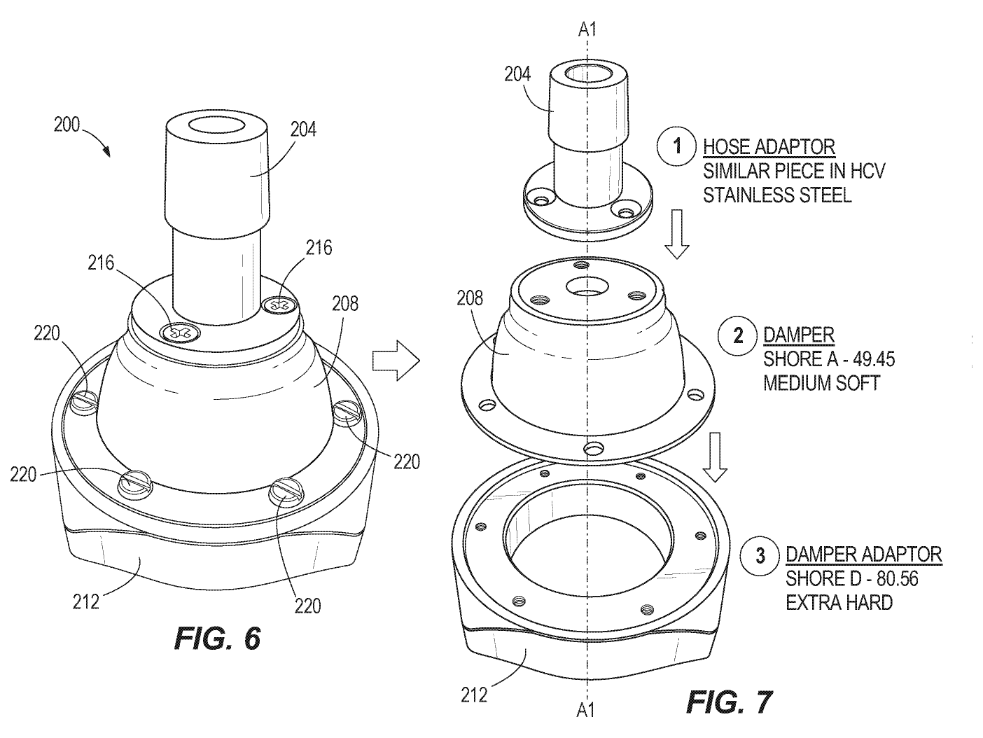

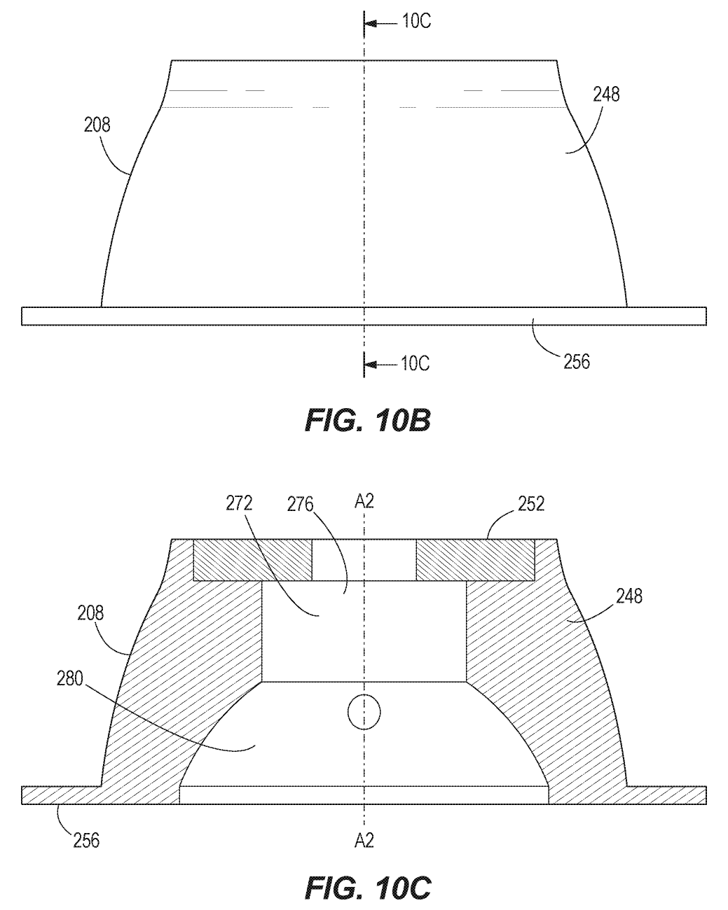

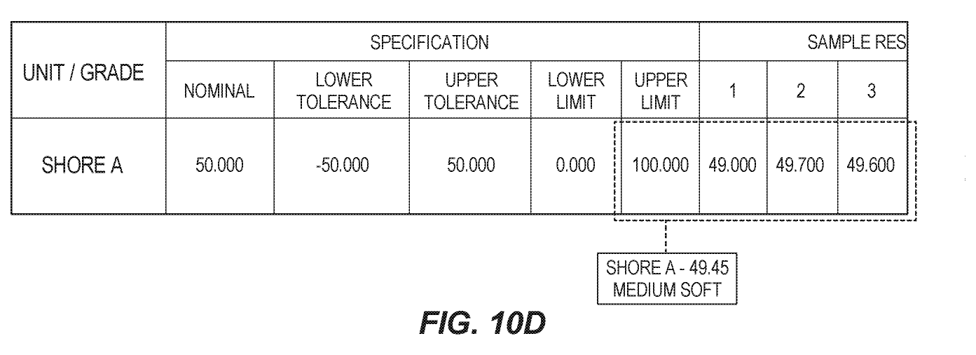

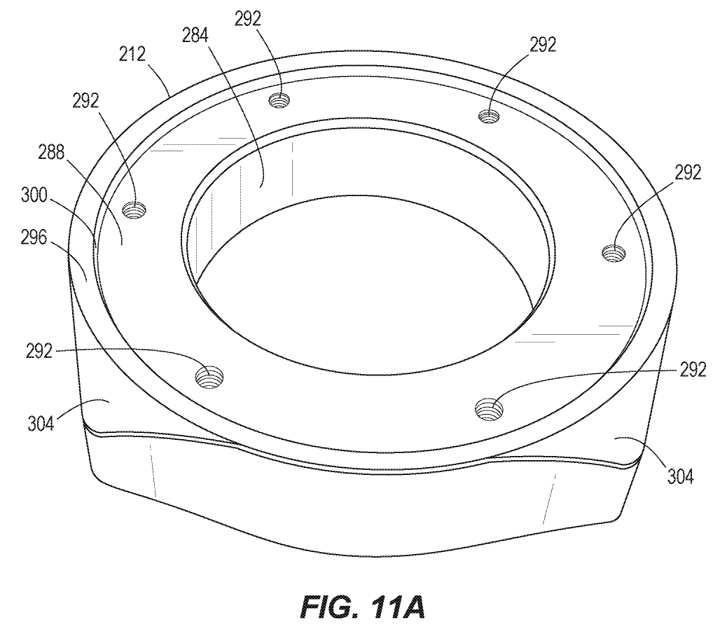

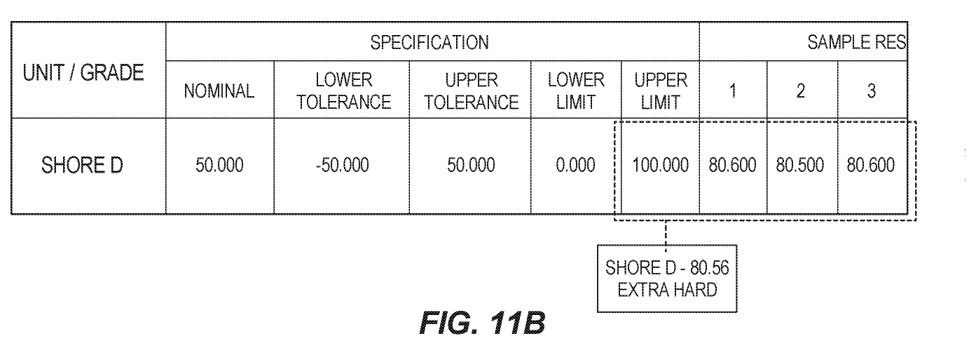

With reference to FIGS. 6 and 7, a damper assembly 200 may be generally similar to the damper assemblies 176, 196 except as is noted and/or as is illustrated by the figures. The damper assembly 200 may include a hose adaptor 204 that connects to the whip 56, a damper adaptor 212 (which may in some embodiments function as a first damper 212 to attenuate vibrations) that connects to a main body of the handles such as, for example, the handles 92, 164, 192, and a damper 208 to attenuate vibration (which may in some embodiments function as a second damper 208 to attenuate vibration). In some embodiments, the second damper 208 may have a Shore hardness that is less than a Shore hardness of the first damper 212 (which may be a damper adaptor 212). In some embodiments, the second damper 208 may have a Shore hardness that is harder than a Shore hardness of the first damper 212. In some embodiments, the damper adaptor 212 may be integrated with a main body of the handles 92, 164, 192. The damper assembly 200 includes a plurality of first fasteners 216 (e.g., first screws) that attach the hose adaptor 204 to the damper 208. The damper assembly 200 also includes a plurality of second fasteners 220 (e.g., second screws) that attach the damper 208 to the damper adaptor 212. The hose adaptor 204 may attach to a corresponding component on the whip 56 and may be made of, for example, plastic or stainless steel. The damper 208 may have a Shore A hardness of 49.45 (i.e., “medium soft”) which is about 50 (see the test results presented in FIG. 10D), or a Shore A hardness of between 45 and 55, or a Shore A hardness of between 40 and 60, or a Shore A hardness of between 35 and 65. The damper adaptor 212 may have a Shore D hardness of 80.56 (i.e., “extra hard”) which is about 80 (see the test results presented in FIG. 11B), or a Shore D hardness of between 75 and 85, or a Shore D hardness of between 70 and 90, or a Shore D hardness of between 65 and 95. These hardness values may apply to any of the respective dampers and damper adaptors described herein. The hose adaptor 204, the damper 208, and the damper adaptor 212 are aligned along a damper assembly axis A1 to form the damper assembly 200.

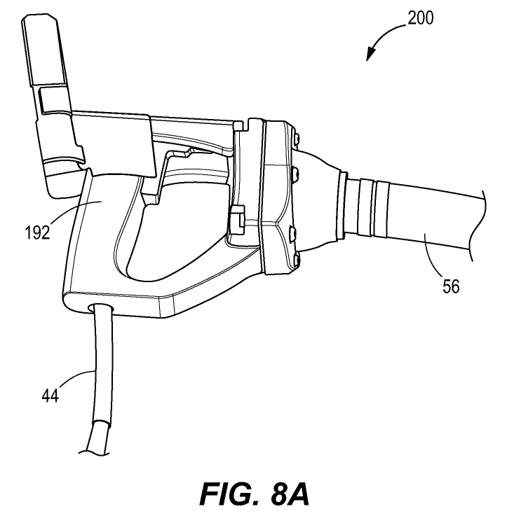

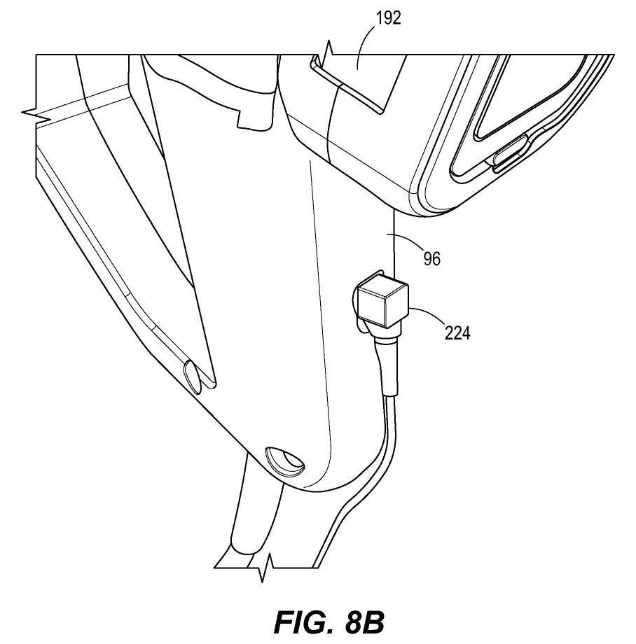

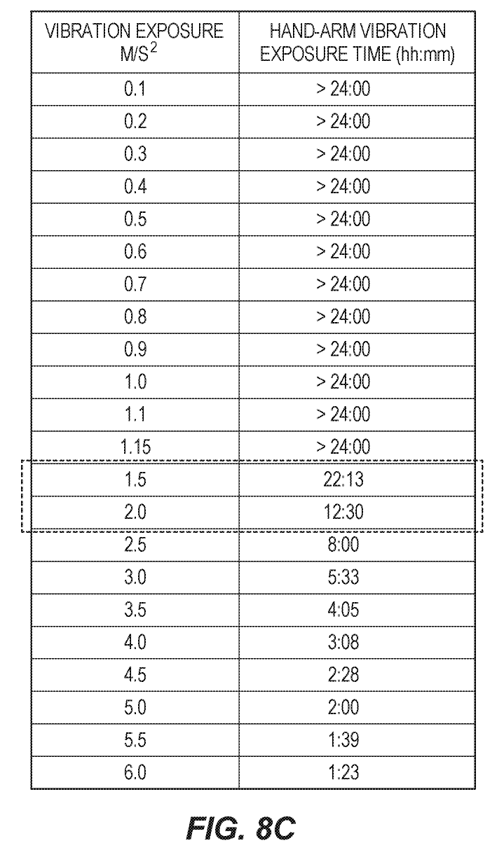

With reference to FIGS. 8A, 8B, and 8C, the handle 192 of FIG. 5 may include the damper assembly 200 of FIGS. 6 and 7. The handle 192 may be equipped for testing purposes with a vibration sensor 224 such as an accelerometer 224 on the grip 96 of the handle 192. FIG. 8C illustrates acceptable exposure times (in an hour:minute format) as a function of the magnitude of vibration, measured in m/s². The handle 192, including the damper assembly 200, may have a magnitude of accelerated hand-arm vibration of 1.81 m/s²when the whip 56 is experiencing a magnitude of accelerated hand-arm vibration of 10.35 m/s², which represents an 82.5% vibration reduction due to the presence of a damper assembly such as the damper assembly 200. According to FIG. 8C, an accelerated hand-arm vibration of 1.81 m/s² allows for an exposure time of between 12 hours, 30 minutes and 22 hours, 13 minutes. Accordingly, use of a damper assembly such as the damper assembly 200 may sufficiently attenuate hand-arm vibrations of the user 76 to allow the user 76 to complete a full 8-hour day or more of work with the concrete vibrator 52.

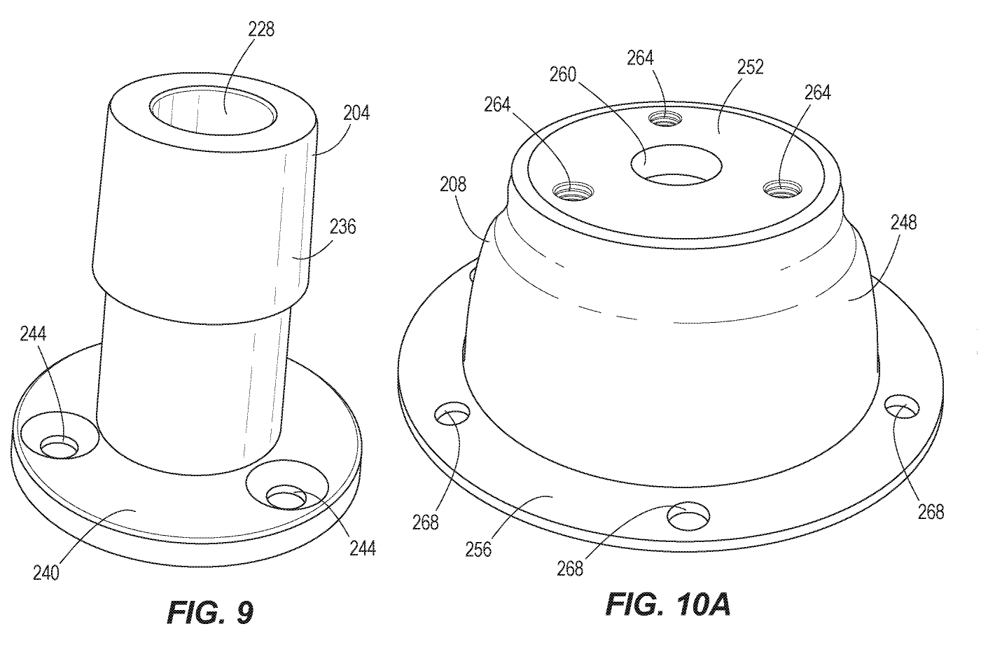

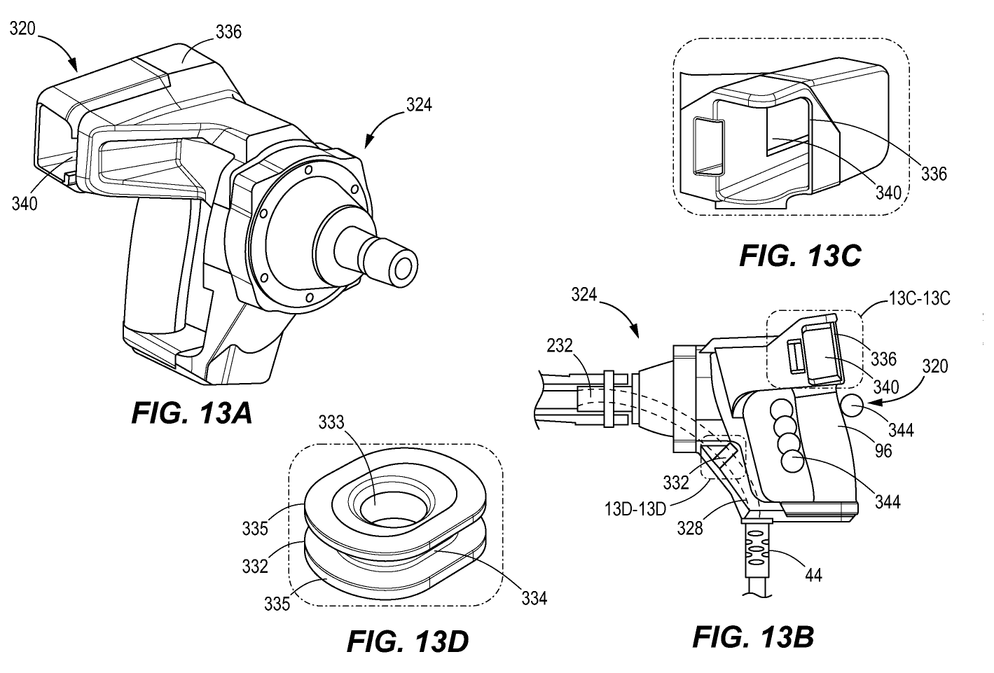

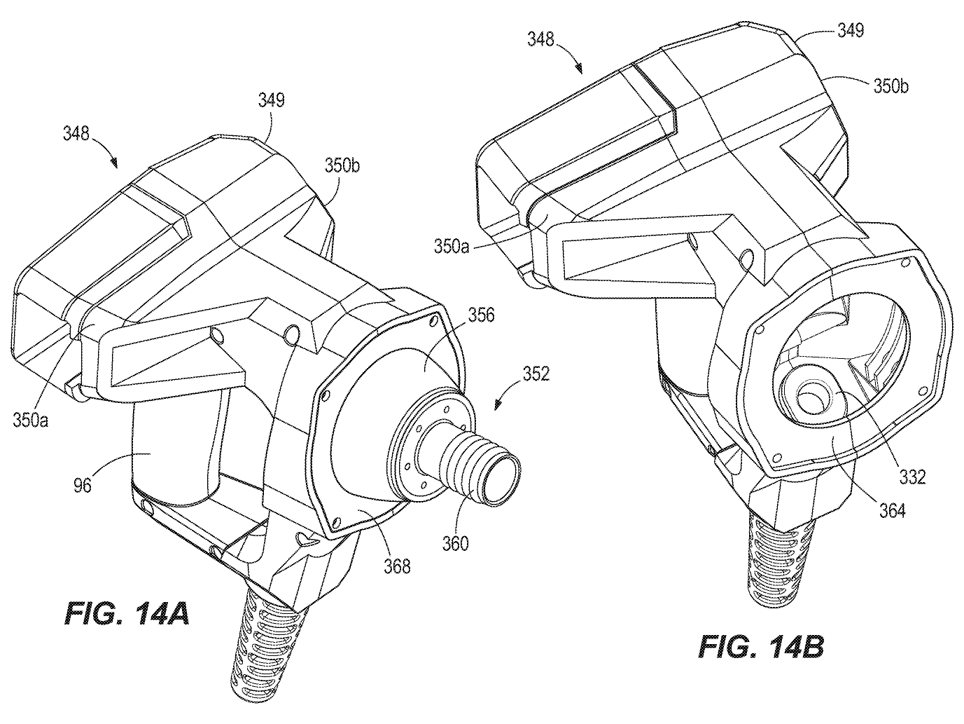

With reference to FIG. 9, the hose adaptor 204 includes a through-hole 228 for passing an electrical cable 232 therethrough (shown schematically in FIG. 13B). The electrical cable 232 extends through the whip 56 and transmits electrical current to the vibrating head 64. In the illustrated embodiment, the hose adaptor 204 includes a barbed fitting 236 that attaches to the whip 56 with, for example, hose clamps. In the illustrated embodiment, the barbed fitting 236 includes a single barb, but more than one barb may be used. The hose adaptor 204 includes a flange 240 at an end of the of the hose adaptor 204 opposite the barbed fitting 236. The flange 240 may include a plurality of bores 244 for receiving the first fasteners 216 to attach the hose adaptor 204 to the damper 208.

With reference to FIGS. 10A, 10B, and 10C, the damper 208 includes a main body 248, a hose adaptor flange 252, and a damper adaptor flange 256 on an opposite side of the main body 248 from the hose adaptor flange 252. The damper 208 includes a through-hole 260 passing through the hose adaptor flange 252, the main body 248, and the damper adaptor flange 256. The main body 248 includes a generally smooth outer periphery with a larger diameter (measured in a plane perpendicular to the through-hole 260 and/or parallel to the hose adaptor flange 252 and/or parallel to the damper adaptor flange 256) at an end of the main body 248 adjacent the damper adaptor flange 256 than at an opposite end of the main body 248 adjacent the hose adaptor flange 252. The hose adaptor flange 252 may include a plurality of threaded bores 264 that positionally correspond to the bores 244 in the flange 240 of the hose adaptor 204 such that the first fasteners 216 may fasten the hose adaptor 204 to the damper 208. The damper adaptor flange 256 may include a plurality of bores 268 for receiving the second fasteners 220 to attach the damper 208 to the damper adaptor 212.

With continued reference to FIG. 10C, the main body 248 of the damper 208 includes a hollow internal cavity 272, which allows electrical wiring to be routed therethrough. The hollow internal cavity 272 includes a cylindrical portion 276 adjacent the hose adaptor flange 252. The hollow internal cavity 272 further includes an expanding cavity 280 (so called because the expanding cavity 280 has a progressively larger diameter when moving in an axial direction away from the cylindrical portion 276) positioned between the cylindrical portion 276 and an end of the main body 248 that is adjacent the damper adaptor flange 256. In some embodiments, the expanding cavity 280 may be defined by a generally frustoconical surface with a convex outer periphery. The hollow internal cavity 272, including in some embodiments one or both of the cylindrical portion 276 and the expanding cavity 280, may be centered about a damper axis A2, which may be collinear with the damper assembly axis A1 when the damper 208 is assembled with other components to form the damper assembly 200.

With reference to FIG. 11A, the damper adaptor 212 includes a central through hole 284 to allow the passage of electrical wiring therethrough. The damper adaptor 212 includes an annular flange 288 to receive the damper adaptor flange 256 and to mount the damper adaptor flange 256 thereto. The annular flange 288 may include a plurality of threaded bores 292 that positionally corresponds to the bores 268 in the damper adaptor flange 256 such that the second fasteners 220 may fasten the damper adaptor 212 to the damper 208. In some embodiments, the bores 292 may be blind bores. A peripheral ridge 296 surrounds the annular flange 288. An inner edge 300 of the peripheral ridge 296 has a diameter that is approximately equal to or slightly larger than (in an embodiment, less than 5% larger than) a diameter of the damper adaptor flange 256 to allow the damper adaptor flange 256 to nest within the peripheral ridge 296. The damper adaptor 212 includes ears 304 (and in some embodiments, includes four ears 304) projecting radially from the through hole 284 and outwardly from the peripheral ridge 296. Each ear 304 may include a hole (e.g., a blind bore) on an opposite side of the damper adaptor 212 from the bores 292 for mounting the damper adaptor 212. In some embodiments, the holes may not be positioned in the ears 304. In some embodiments, the holes are threaded.

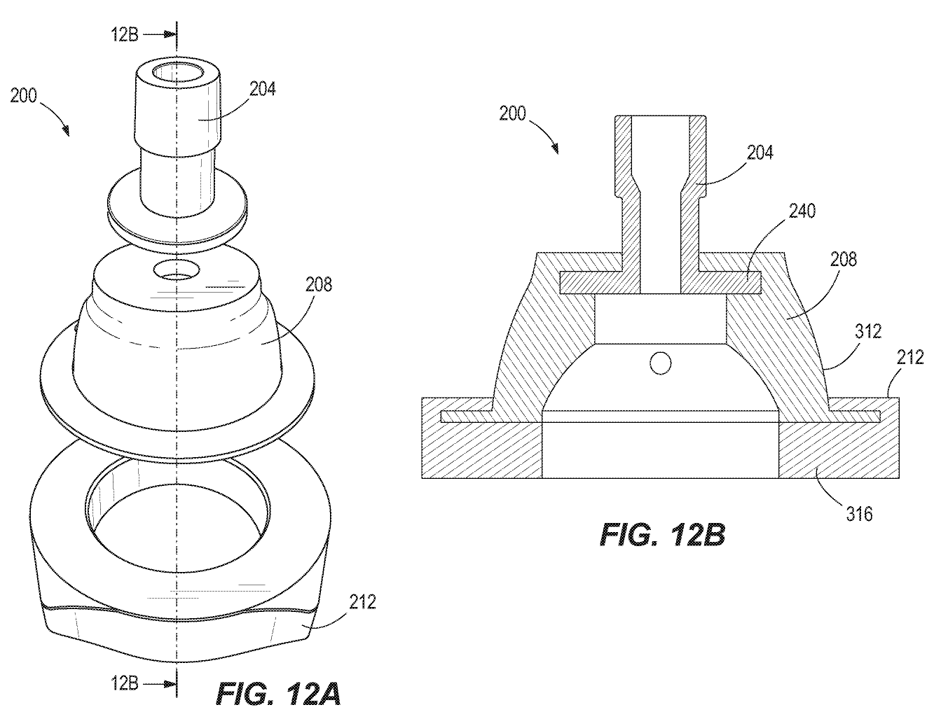

With reference to FIGS. 12A and 12B, the damper assembly 200, which includes the hose adaptor 204, the damper 208, and the damper adaptor 212, may be assembled without using fasteners, such as the first fasteners 216 and the second fasteners 220. For example, the hose adaptor 204, the damper 208, and the damper adaptor 212 may be assembled by using one or more overmolding processes. In one embodiment, the damper assembly 200 is assembled and fastened together by a double-overmold construction or by a two-shot overmold construction. For example, a first overmold 312 may encase the flange 240 of the hose adaptor 204. The first overmold 312 may form the damper 208 and/or a portion of the damper 208 such as the main body 248 of the damper 208 (e.g., the first overmold 312 may form an elastic component of the damper 208 which, in some embodiments, is a second damper 208), or the first overmold 312 may attach the flange 240 of the hose adaptor 204 to the damper 208 (i.e., by overmolding the flange 240 to the damper 208). A second overmold 316 may form the damper adaptor 212 or a portion of the damper adaptor 212 (e.g., the second overmold 316 may form an elastic component of the damper adaptor 212 which, in some embodiments, is a first damper 212) and may encase the damper adaptor flange 256. In some embodiments, the second overmold 316 may be applied before the first overmold 312, in some embodiments, the first overmold 312 may be applied before the second overmold 316, and in some embodiments the first overmold 312 and the second overmold 316 may be applied simultaneously. In some embodiments, a “double-overmold” construction may refer to a construction in which the flange 240 is overmolded to the damper 208 by the first overmold 312, and the damper adaptor flange 256 of the damper 208 is overmolded to the damper adaptor 212 by the second overmold 316 (or in some embodiments, the damper adaptor 212 is formed by the second overmold 316). In a double-overmold construction, two overmolds fasten adjacent components together with one overmold overlapping another overmold.

With reference to FIGS. 13A, 13B, 13C, and 13D, a handle 320 (e.g., a pistol-grip handle 320 as shown in the illustrated embodiment) may include similar components as, and may function similarly as, the handles 92, 164, 192 except as is noted and/or as is illustrated by the figures. The handle 320 includes a damper assembly 324 that may be similar generally similar to the damper assemblies 176, 196, 200 except as is noted and/or as is illustrated by the figures. An electrical wiring path 328 is schematically illustrated in FIG. 13B, showing a path of electrical wiring passing through the handle 320 from the cable 44 to the whip 56. A strain relief component 332 is positioned within the handle 320 and along the electrical wiring path 328 to support electrical wiring (FIGS. 13B and 13D). The strain relief component 332 is annular and defines an electrical wiring pathway 333 therethrough. The strain relief component 332 includes a circumferential valley 334 positioned between two circumferential ridges 335, the valley 334 assisting with mounting the strain relief component 332 within the handle 320. In the embodiment of FIG. 13B, the electrical wiring path 328 does not pass through the grip 96 of the handle 320.

With continued reference to FIGS. 13A, 13B, 13C, and 13D, the handle 320 includes a handle receptacle 336 defining a pocket 340 in which a controller and/or a control panel (e.g., the control panel 104 described elsewhere herein) is selectively receivable and selectively removable therefrom. The control panel 104 may be located on a remote control unit 105 (FIGS. 1D, 1E, 2A, 2B, and 2C). The remote control unit 105 may be battery powered (e.g., powered by a rechargeable battery) and may charge while received within the pocket 340 (e.g., by receiving electrical charging current from the battery pack 22 when within the handle receptacle 336). In some embodiments, the remote control unit 105 may be charged in another fashion such as by plugging the remote control unit 105 into an external power source such as to an AC power grid or into an external DC power source. The remote control unit 105 may communicate wirelessly (e.g., via Bluetooth, WIFI, etc.) with the electronic control unit 31 inside the motor control unit 30. For example, when the remote control unit 105 is removed from the handle receptacle 336 (in other words, removed from the pocket 340), then the remote control unit 105 may communicate wirelessly with the electronic control unit 31, and when the remote control unit 105 is received in the handle receptacle 336 (that is, received in the pocket 340), then the remote control unit 105 may communicate with the electronic control unit 31 through the cable 44. In some embodiments, the remote control unit 105 may communicate wirelessly with the electronic control unit 31 when the remote control unit 105 is removed from the handle receptacle 336 and also when the remote control unit 105 is received in the handle receptacle 336. The remote control unit 105 may transmit an input signal to the electronic control unit 31 based on a user input to the control panel 104. The electronic control unit 31 may transmit a control signal to the high cycle concrete vibrator 52 along the cable 44 based on the input signal transmitted to the electronic control unit 31 by the remote control unit 105 to control an operation of the high cycle concrete vibrator 52. Fingers 344 are schematically illustrated in FIG. 13B to show how the user’s left hand 120 or right hand 124 may hold the grip 96.

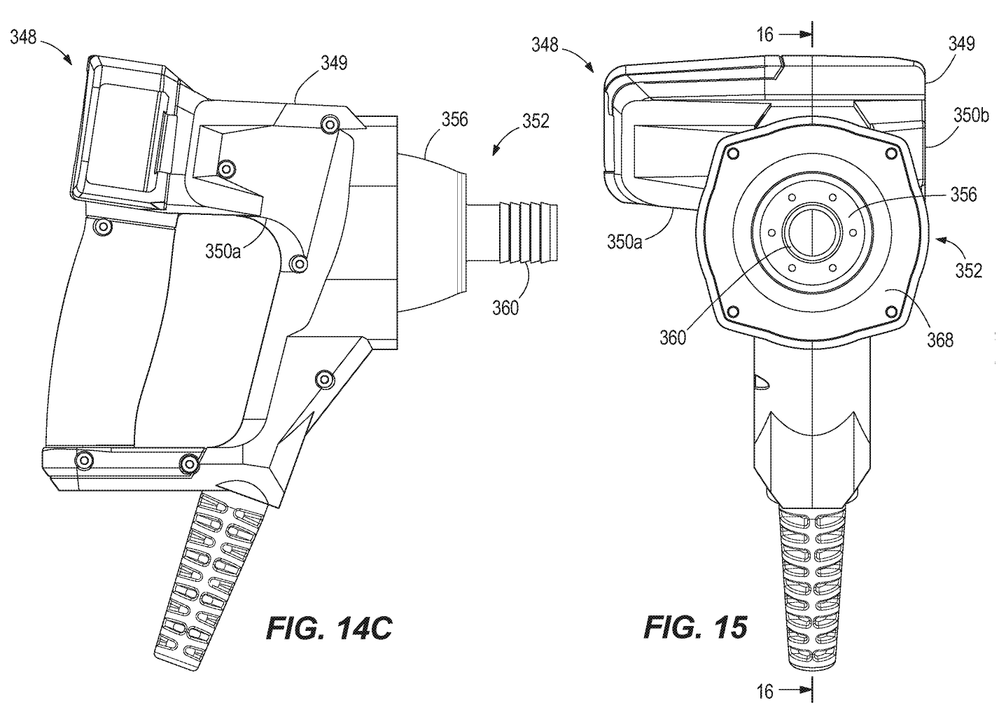

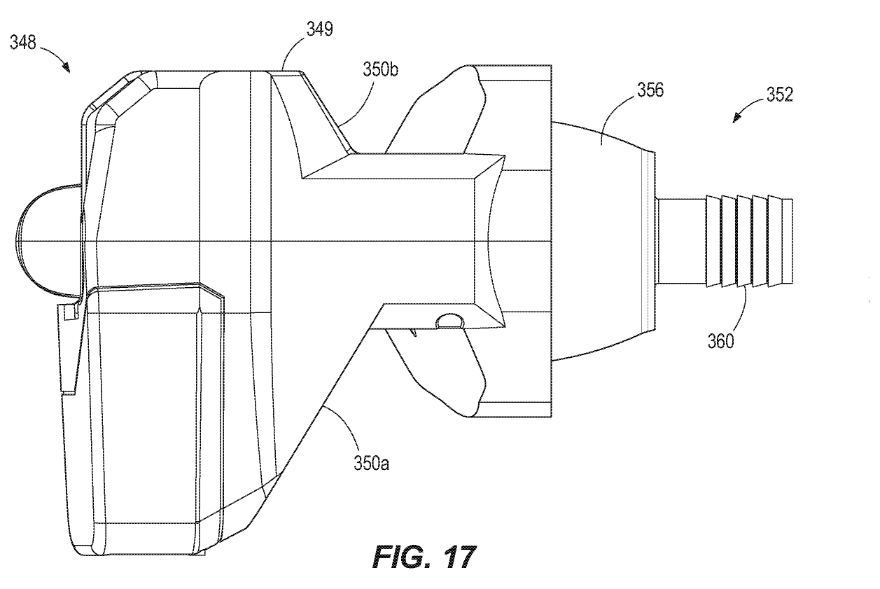

With reference to FIGS. 14A, 14B, 14C, 15, 16, and 17, a handle 348 (e.g., a pistol-grip handle 348 as shown in the illustrated embodiment) may include similar components as, and may function similarly as, the handles 92, 164, 192, 320 except as is noted and/or as is illustrated by the figures. The handle 348 has a main body 349 including a first clamshell half 350a and a second clamshell half 350b. The first clamshell half 350a and the second clamshell half 350b form the grip 96 and an interior cavity 351. The handle 348 includes a damper assembly 352. The damper assembly 352 includes a damper 356 and a hose adaptor 360, both which may respectively be generally similar to the damper 208 and the hose adaptor 204, except as is noted and/or as is illustrated by the figures. The damper assembly 352 further includes a damper adaptor 364 that is integrally formed with the clamshell halves 350a, 350b (FIG. 14B). The damper assembly 352 includes a damper adaptor flange 368 that, for example, may be a component of the damper 356 or may be a separate component. The damper adaptor flange 368 is configured for mounting to the damper adaptor 364.

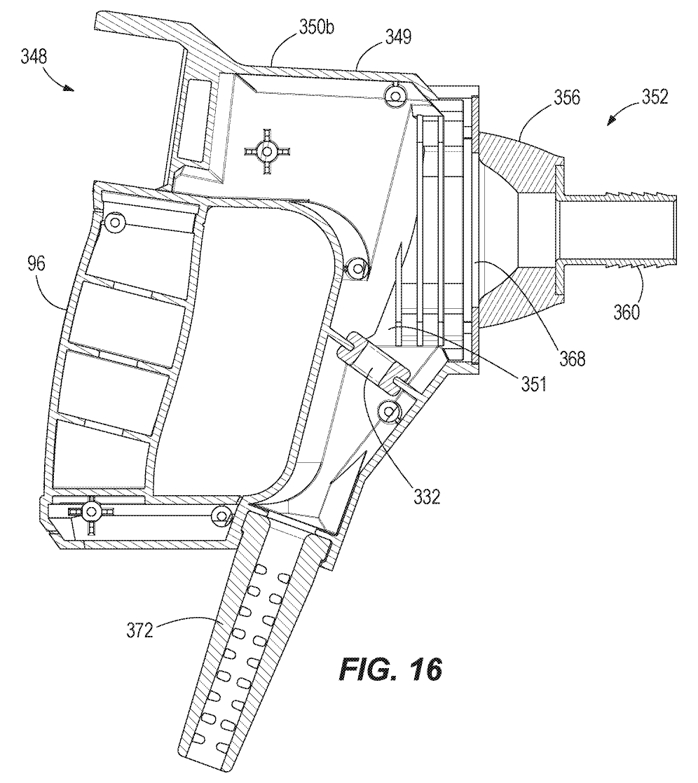

With reference to FIG. 16, the handle 348 includes an upper strain relief component such as the strain relief component 332. The strain relief component 332 is positioned within the handle 348. The handle 348 includes a lower strain relief component 372 at a bottom of the handle 348 such that the lower strain relief component 372 protrudes from the main body 349. The lower strain relief component 372 supports the cable 44 as it enters the handle 348 (i.e., the lower strain relief component 372 supports the cable 44 as the cable 44 extends into the interior cavity 351).

In some embodiments, the damper assembly 352 (or any one of the damper assemblies described herein) may be the only damping component configured to attenuate vibration between the concrete vibrator (e.g., the high cycle concrete vibrator 52) and the user’s hand 120, 124 (that is, between the concrete vibrator and the handles described herein) in the concrete vibrator system. In some embodiments, two or more damping components (e.g., two or more damper assemblies described herein, for example two or more identical damper assemblies or two or more different damper assemblies) may be positioned between the concrete vibrator and the user’s hand 120, 124.

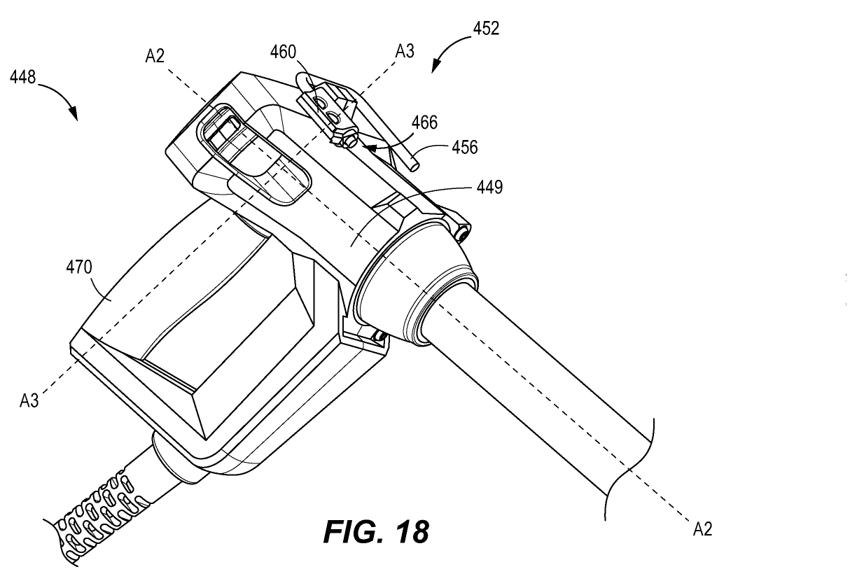

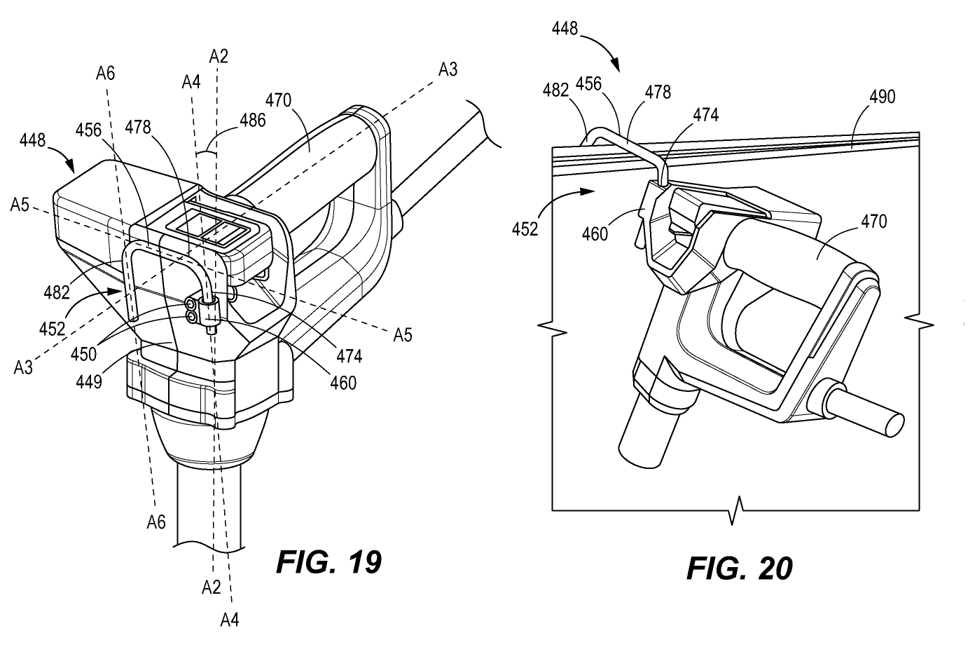

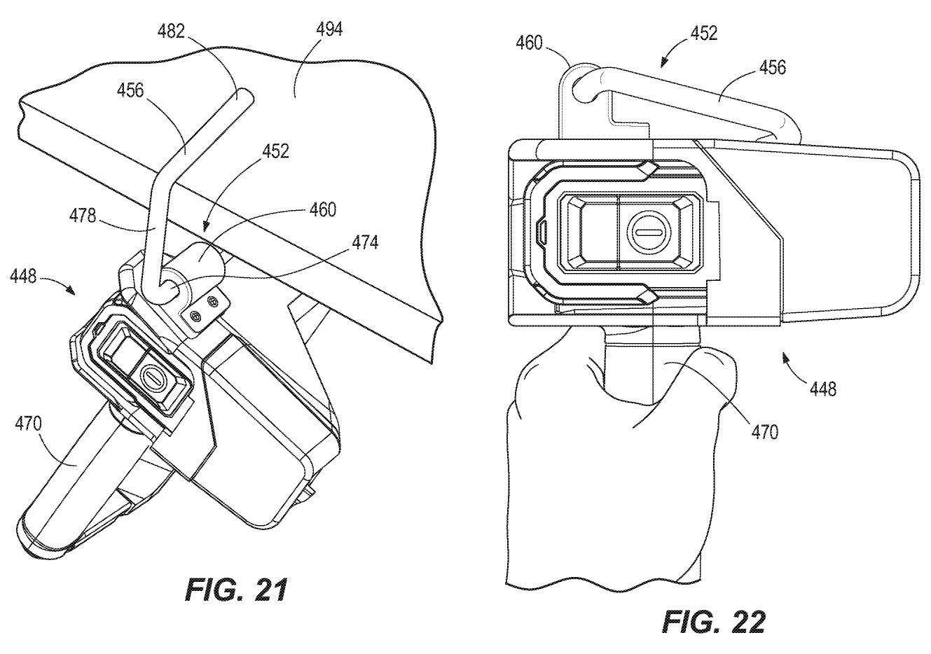

With reference to FIG. 18, a handle 448 (e.g., a pistol-grip handle 448 as shown in the illustrated embodiment) may include similar components as, and may function similarly as, the handles 92, 164, 192, 320, 348 except as is noted and/or as is illustrated by the figures. The handle 448 includes a grip portion 470 and a longitudinal grip portion axis A3 extending along the grip portion 470. The damper axis A2 extends transverse to, and in some embodiments perpendicular or generally perpendicular to, the grip portion axis A3. The handle 448 includes a hook assembly 452 (e.g., a rafter hook 452) that is pivotable between a retracted position as shown in FIGS. 18, 19, and 22 and an extended “hooking” position as shown in FIGS. 20 and 21. The hook assembly 452 may be rotatable by 90 degrees, approximately 90 degrees, between 60 degrees and 120 degrees, or between 30 degrees and 150 degrees between the retracted position and the extended position. The hook assembly 452 includes a hook 456, a mount 460, and a detent assembly 466 that selectively retains the hook 456 in the retracted position or in the extended position. The mount 460 may be mounted to a main body 449 of the handle 448 by one or more fasteners 450 such as, for example, two screws 450. FIGS. 18 and 19 illustrate the hook assembly 452 fastened to different locations on the main body 449.

With reference to FIGS. 19 and 20, the hook 456 may include a proximate portion 474 proximate the mount 460, an intermediate portion 478 adjacent to the proximate portion 474 and transverse to the proximate portion 474, and a distal portion 482 distal from the mount 460 and transverse to the intermediate portion 478. The distal portion 482 may extend parallel to the proximate portion 474. The proximate portion 474 defines a longitudinal proximate portion axis A4, the intermediate portion 478 defines a longitudinal intermediate portion axis A5, and the distal portion 482 defines a longitudinal distal portion axis A6. The proximate portion axis A4 may be parallel or generally parallel to the distal portion axis A6 and/or may be parallel or generally parallel to the damper axis A2. The intermediate portion axis A5 may be transverse to the grip portion axis A3 when the hook 456 is in the retracted position and may be parallel or generally parallel to the grip portion axis A3 when the hook 456 is in the extended position. An angle 486 may extend between the proximate portion axis A4 (and/or the distal portion axis A6) and the damper axis A2, and the angle 486 may be less than 30 degrees, less than 15 degrees, less than 10 degrees, or less than 5 degrees.

With reference to FIG. 20, the hook 456 may support the handle 448 on a support 490 by bearing a normal force on the intermediate portion 478 of the hook 456. With reference to FIG. 21, the hook 456 may support the handle 448 on a support 494 by bearing a normal force on the distal portion 482. With reference to FIG. 22, a user may grip the grip portion 470 such that the hook assembly 452 is on an opposite side of the handle 448 from the grip portion 470. The hook assembly 452 may enable the handle 448 to be supported by a belt of a user or by another support surface.

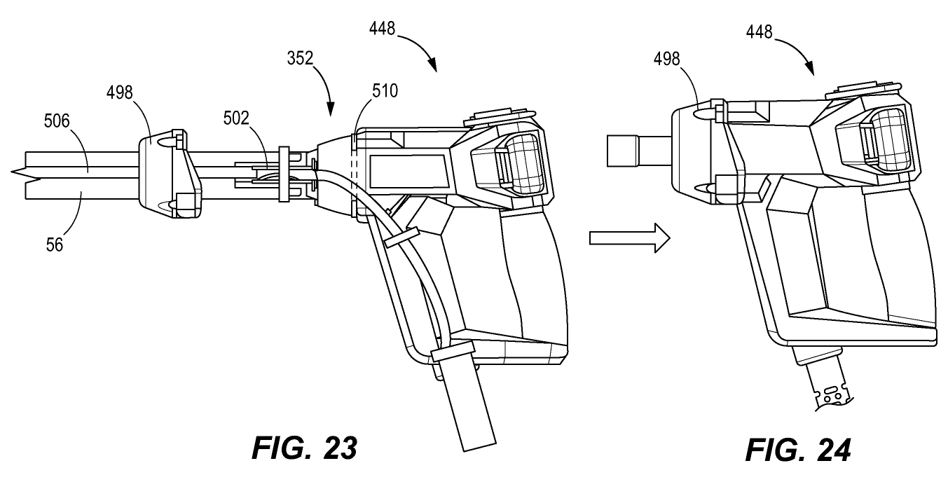

With reference to FIGS. 23 and 24, the handle 448 includes the damper assembly 352 and a cover 498 that fits axially over the whip 56 to cover the damper assembly 352. From the frame of reference of FIGS. 23 and 24, the cover 498 slides to the right to abut the handle 448 and cover the damper assembly 352. The cover 498 may act as a second damper 498 to inhibit vibrations felt by a user of the handle 448 (or, in some embodiments, the damper 356 may be considered to be a second damper 356, and the cover 498 may act as a first damper 498). An isolator grommet 502 is positioned within an end of the whip 56 that is adjacent to the damper assembly 352 to provide strain relief to electrical wiring 506 within the whip 56. A gasket 510 is positioned between the damper assembly 352 and the main body 449 of the handle 448 and more particularly, between the damper 356 (and/or the damper adaptor flange 368) and the main body 449 of the handle 448. The gasket 510 may inhibit water infiltration into the damper assembly 352 and/or the main body 449 of the handle 448. In some embodiments, one or both of the damper adaptor flange 368 and the hose adaptor 360 may be made entirely of, or may include in part, hard plastic.

Although the invention has been described in detail with reference to certain preferred embodiments, variations and modifications exist within the scope and spirit of one or more independent aspects of the invention as described.

Various features of the invention are set forth in the following claims.

What is claimed is:

1. A concrete vibrator system comprising:
a portable power unit including:
a backpack including a strap to allow a user to carry the portable power unit on a back of the user,
a battery receptacle unit, and
a battery pack attached to the battery receptacle unit,
a cable extending from the portable power unit, the cable configured to transmit electrical current from the battery pack;
a high cycle concrete vibrator coupled to the cable to receive the electrical current from the battery pack, the high cycle concrete vibrator including:
a whip including a first end and an opposite, second end, and
a vibrating head coupled to the second end of the whip, the vibrating head including an onboard electric motor configured to rotate a drive shaft to which an eccentric mass is affixed; and
a pistol-grip handle positioned between the portable power unit and the whip, the cable extending into the pistol-grip handle, the pistol-grip handle including:
a main body including a grip, and
a damper assembly positioned between the main body and the first end of the whip, the damper assembly configured to attenuate vibration transmitted from the vibrating head to the grip.

2. The concrete vibrator system of claim 1, wherein the portable power unit includes a power unit control panel positioned on the portable power unit, the power unit control panel configured such that the user interacts with actuators on the power unit control panel to control an operation of the high cycle concrete vibrator.

3. The concrete vibrator system of claim 1, wherein the portable power unit includes a motor control unit including an electronic control unit within the motor control unit, the electronic control unit configured to send a control signal to the high cycle concrete vibrator, and wherein the pistol-grip handle includes a handle control panel that is operable to be controlled by a thumb of a hand of the user while the hand of the user is holding the grip.

4. The concrete vibrator system of claim 3, wherein the handle control panel transmits an input signal to the electronic control unit in response to a user input, and wherein the electronic control unit transmits a control signal to the high cycle concrete vibrator in response to the input signal from the handle control panel to control an operation of the high cycle concrete vibrator.

5. The concrete vibrator system of claim 3, wherein the handle control panel transmits an input signal to the high cycle concrete vibrator in response to a user input to control an operation of the high cycle concrete vibrator.

6. The concrete vibrator system of claim 3, wherein the handle control panel is located on a remote control unit that is selectively receivable in a receptacle positioned on the pistol-grip handle, and wherein the remote control unit is battery powered and configured to receive a charging current from the battery pack when the remote control unit is received within the receptacle.

7. The concrete vibrator system of claim 1, wherein:
the damper assembly includes a first damper coupled to the main body of the pistol-grip handle, the first damper having a first Shore hardness,
the damper assembly includes a second damper coupled between the first damper and the high cycle concrete vibrator, the second damper having a second Shore hardness that is less than the first Shore hardness of the first damper, and
the damper assembly is configured to attenuate vibration transmitted from the high cycle concrete vibrator to the grip.

8. The concrete vibrator system of claim 7, wherein the first damper has a Shore D hardness between 75 and 85, and wherein the second damper has a Shore A hardness between 45 and 55.

9. The concrete vibrator system of claim 1, wherein:
the damper assembly includes a hose adaptor, a damper adaptor configured to connect to the main body of the pistol-grip handle, and a damper positioned therebetween,
the hose adaptor is fastened to the damper with first fasteners, and
the damper is fastened to the damper adaptor with second fasteners.

10. The concrete vibrator system of claim 1, wherein the damper assembly includes a hose adaptor coupled to the whip, a damper adaptor coupled to the main body of the pistol-grip handle, and a damper positioned therebetween.

11. The concrete vibrator system of claim 1, wherein:
the pistol-grip handle includes a strain relief component configured to protect electrical wiring passing through the pistol-grip handle,
the electrical wiring does not pass through the grip, and
the damper assembly includes a hose adaptor configured to connect to the whip and having a barbed fitting, a damper adaptor configured to connect to the main body of the pistol-grip handle, and a damper positioned therebetween, the damper having a Shore A hardness of about 50, the damper including a hollow internal cavity including a cylindrical portion and an expanding cavity, the hollow internal cavity configured to allow the electrical wiring to be routed therethrough.

12. The concrete vibrator system of claim 1, wherein the damper assembly includes a damper having a Shore A hardness between 35 and 65.

13. A concrete vibrator system comprising:
a portable power unit including:
a battery receptacle unit, and
a battery pack attached to the battery receptacle unit,
a cable extending from the portable power unit, the cable configured to transmit electrical current from the battery pack;
a high cycle concrete vibrator coupled to the cable to receive the electrical current from the battery pack, the high cycle concrete vibrator including:
a whip including a first end and an opposite, second end, and
a vibrating head coupled to the second end of the whip, the vibrating head including an onboard electric motor configured to rotate a drive shaft to which an eccentric mass is affixed; and
a pistol-grip handle positioned between the portable power unit and the whip, the cable extending into the pistol-grip handle, the pistol-grip handle including:
a main body including a grip,
a handle receptacle, and
a handle control panel that is operable to be controlled by a thumb of a user’s hand while the user’s hand is holding the grip, wherein the handle control panel is located on a remote control unit that is selectively receivable within the handle receptacle.

14. The concrete vibrator system of claim 13, wherein:
the portable power unit includes a motor control unit including an electronic control unit within the motor control unit, the electronic control unit configured to send a control signal to the high cycle concrete vibrator,
the handle control panel is configured to send a signal to the electronic control unit in response to a user input, and
the electronic control unit is configured to send a control signal to the high cycle concrete vibrator in response to the signal from the handle control panel to control an operation of the high cycle concrete vibrator.

15. The concrete vibrator system of claim 14, wherein the handle control panel is located on a remote control unit that is selectively receivable in a receptacle positioned on the pistol-grip handle, and wherein the remote control unit is battery powered and configured to receive a charging current from the battery pack when the remote control unit is received within the receptacle.

16. The concrete vibrator system of claim 14, wherein the handle control panel is located on a remote control unit that is selectively receivable in a receptacle positioned on the pistol-grip handle, and wherein the handle control panel is configured to wirelessly send a signal to the electronic control unit in response to a user input.

17. A pistol-grip handle for a concrete vibrator, the pistol-grip handle comprising:
a main body including a first clamshell half and a second clamshell half, the first and second clamshell halves forming a grip and an interior cavity;
a strain relief component configured to support an electrical cable extending into the interior cavity, the electrical cable configured to transmit electrical current from a power source to the concrete vibrator; and
a damper assembly including:
a first damper coupled to the main body and having a first Shore hardness, and
a second damper coupled between the first damper and the concrete vibrator, the second damper having a second Shore hardness that is less than the first Shore hardness of the first damper;
wherein the damper assembly is configured to attenuate vibration transmitted from the concrete vibrator to the grip.

18. The pistol-grip handle of claim 17, wherein the second damper has a Shore A hardness between 35 and 65.

19. The pistol-grip handle of claim 17, wherein the first damper has a Shore D hardness between 65 and 95.

20. The pistol-grip handle of claim 17, wherein the first and second dampers are formed by a double-overmold process.
